(19) United States
(12) Patent Application Publication
(10) Pub. No.: US 2024/0217367 A1
(43) Pub. Date: Jul. 4, 2024

(54) CHARGING APPARATUS FOR VEHICLE, METHOD OF CONTROLLING DISPLAY THEREOF AND COMPUTER-READABLE STORAGE MEDIUM

(71) Applicants: HYUNDAI MOTOR COMPANY, Seoul (KR); KIA CORPORATION, Seoul (KR); YURA CORPORATION CO.,LTD., Seongnam-si (KR)

(72) Inventors: Yun Jae Jung, Suwon-si (KR); Woo Gwon Sim, Seongnam-si (KR); Young Hoo Yoon, Suwon-si (KR)

(73) Assignees: HYUNDAI MOTOR COMPANY, Seoul (KR); KIA CORPORATION, Seoul (KR); YURA CORPORATION CO.,LTD., Seongnam-si (KR)

(21) Appl. No.: 18/224,675

(22) Filed: Jul. 21, 2023

(30) Foreign Application Priority Data
Dec. 30, 2022 (KR) 10-2022-0190487

(51) Int. Cl. B60L 53/62; B60L 53/30

(52) U.S. Cl. CPC B60L 53/62; B60L 53/305

(57) ABSTRACT

A charging apparatus for a vehicle includes a display unit displaying a charging state and a fault code for a cause of a charging failure; a storage unit storing a program for controlling the display unit when a failure is detected during a charging operation; and a controller controlling the charging operation and controlling the display unit to display a fault code when a failure is detected during the charging operation.

### CROSS-REFERENCE TO RELATED APPLICATION

This application claims the benefit of and priority to Korean Patent Application No. 10-2022-0190487, filed on Dec. 30, 2022, the entire contents of which are incorporated herein by reference.

### TECHNICAL FIELD

The present disclosure relates to a charging apparatus for a vehicle, a method of controlling display thereof, and a computer-readable storage medium.

### BACKGROUND

In general, a charging apparatus for a vehicle is used to charge a battery of an electric vehicle. Such a charging apparatus for a vehicle includes a slow charging apparatus that enables a driver to easily charge a vehicle at home using AC power. The slow charging cable includes a connector connected to a charging outlet of an electric vehicle, an ICCB monitoring and controlling power supplied from mains power to a battery of the vehicle, and a plug connected to an outlet of mains power.

When the connector is connected to the charging outlet of the electric vehicle and when charging is recognized to be ready, the ICCB switches on an internal relay of the ICCB so that mains power is controlled to be applied to the vehicle. In addition, the ICCB performs a protection function to protect a user and the vehicle from overvoltage or overcurrent during battery charging. In addition, the ICCB also displays a connection state with the vehicle, a maximum charging current value, and a charging progress state on the display device during charging.

A liquid crystal display (LCD) is generally used as a display device. However, in the case of the LCD, there is a problem in that size, cost, and weight may increase due to a wide screen and peripheral circuits.

### SUMMARY

Embodiments of the present disclosure provide a charging apparatus for a vehicle, a method of controlling display thereof, and a computer-readable storage medium, capable of reducing size, cost, and weight, and reducing a development period, as compared to systems in which a conventional liquid crystal display (LCD) is utilized.

According to an embodiment, a charging apparatus for a vehicle includes: a display unit displaying a charging state and a fault code for a cause of a charging failure; a storage unit storing a program for controlling the display unit when a failure is detected during a charging operation; and a controller controlling the charging operation and controlling the display unit to display a fault code when a failure is detected during the charging operation.

The display unit may include one or more light emitting diodes (LEDs).

The controller may control ON/OFF switching of each of the one or more LEDs according to the fault code.

The controller may control the one or more LEDs, which corresponds to a magnitude of a charging current, to be turned on during the charging operation.

The one or more LEDs may be arranged in a vertical direction or horizontal direction and include LEDs ranging from an LED corresponding to a most significant bit (MSB) to an LED corresponding to a least significant bit (LSB) in a certain direction.

The fault code may be a binary code having a preset number of bits.

The storage unit may pre-store a fault code corresponding to details of the failure.

The controller may control the display unit so that up to a predetermined number of bits including an MSB display a fault item and bits other than the predetermined number of bits displaying the fault item display details included in each fault item.

The fault item may include at least one of current, voltage, diagnosis, control pilot (CP), and temperature, and the details include at least one of occurrences of leakage current, overcharging current, overcharging voltage, undercharging voltage, relay self-diagnosis failure, self-diagnosis failure of a zero-phase current transformer (ZCT), abnormality of a CP voltage, overtemperature of a connector, overtemperature of a plug, and overtemperature of a printed circuit board (PCB).

According to another embodiment, a method of controlling display of a charging apparatus for a vehicle includes displaying a charging state during a charging operation and detecting a failure; and controlling a display unit to display a fault code, when the failure is detected.

The display unit may include one or more light emitting diodes (LED).

The controlling of the display unit may include controlling ON/OFF switching of the one or more LEDs according to the fault code.

The controlling of the display unit may include controlling the one or more LEDs, which corresponds to a magnitude of a charging current, to be turned on during the charging operation.

The one or more LEDs may be arranged in a vertical direction or horizontal direction and include LEDs ranging from an LED corresponding to a most significant bit (MSB) to an LED corresponding to a least significant bit (LSB) in a certain direction.

The fault code may be a binary code having a preset number of bits.

A fault code corresponding to details of the failure may be pre-stored.

The controlling of the display unit may include performing controlling so that up to a predetermined number of bits including an MSB display a fault item and bits other than the predetermined number of bits displaying the fault item display details included in each fault item.

The fault item may include at least one of current, voltage, diagnosis, control pilot (CP), and temperature, and the details include at least one of occurrences of leakage current, overcharging current, overcharging voltage, undercharging voltage, relay self-diagnosis failure, self-diagnosis failure of a zero-phase current transformer (ZCT), abnormality of a CP voltage, overtemperature of a connector, overtemperature of a plug, and overtemperature of a printed circuit board (PCB). According to yet another embodiment, there is provided a computer-readable storage medium storing a program for executing the method described above.

### BRIEF DESCRIPTION OF THE DRAWINGS

The above and other aspects, features, and advantages of the present disclosure should be more apparent from the following detailed description taken in conjunction with the accompanying drawings, in which:

FIG. 1 illustrates an in-cable control box (ICCB) included in a charging apparatus for a vehicle connecting a mains power to an electric vehicle, according to an embodiment of the present disclosure;

FIG. 2 is a diagram illustrating a display module provided in an ICCB, according to an embodiment of the present disclosure;

FIG. 3 is an internal block diagram of a control device of a display module provided in an ICCB, according to an embodiment of the present disclosure;

FIGS. 4A and 4B are diagrams illustrating a process of controlling ON/OFF switching of each of a plurality of light emitting diodes (LEDs) according to a stored fault code, according to an embodiment of the present disclosure;

FIGS. 5A and 5B are diagrams illustrating fault codes classified according to fault items and statements, according to an embodiment of the present disclosure;

FIG. 6 is a diagram illustrating a plurality of LEDs arranged in a horizontal direction, according to an embodiment of the present disclosure;

FIG. 7 is a diagram illustrating a label attached to an outer surface of an ICCB, according to an embodiment of the present disclosure;

FIG. 8 is a flowchart illustrating a display method of a display module provided in an ICCB, according to an embodiment of the present disclosure; and

FIG. 9 is a block diagram of a computer device capable of fully or partially implementing a control device of a display module provided in an ICCB, according to an embodiment of the present disclosure.

### DETAILED DESCRIPTION

Hereinafter, embodiments of the present disclosure are described with reference to the accompanying drawings. However, the embodiments of the present disclosure may be modified in many different forms, and the scope of the present disclosure is not limited to the embodiments described below. The shapes and sizes of elements in the drawings may be exaggerated for clearer description, and elements indicated by the same reference numerals in the drawings are the identical or equivalent elements.

When a component, device, element, or the like of the present disclosure is described as having a purpose or performing an operation, function, or the like, the component, device, or element should be considered herein as being “configured to” meet that purpose or perform that operation or function.

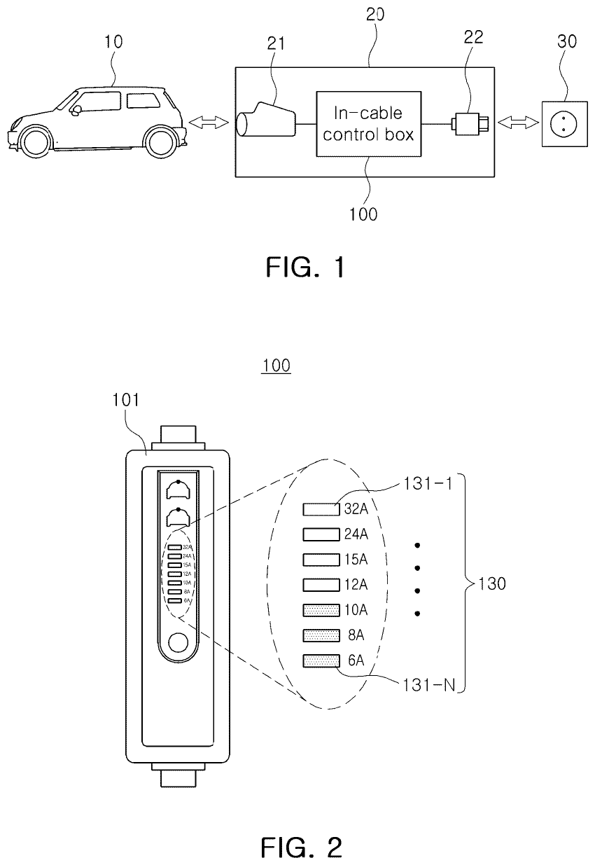

FIG. 1 illustrates an in-cable control box (ICCB) included in a charging apparatus for a vehicle connecting a mains power to an electric vehicle, according to an embodiment of the present disclosure. FIG. 2 is a view illustrating a display module provided in an ICCB, according to an embodiment of the present disclosure.

As illustrated in FIG. 1, a charging apparatus for a vehicle 20 includes: a connector 21 connected to an electric vehicle 10, a plug 22 connected to an outlet 30 of a mains power, and an ICCB 100 monitoring and controlling charging power applied to a battery of the vehicle 10 from the mains power.

The electric vehicle 10 is a vehicle driven by electricity supplied from an energy storage device, such as a rechargeable battery, and may be an xEV including, for example, an electric vehicle (EV), a hybrid electric vehicle (HEV), and a plug-in hybrid electric vehicle (PHEV), battery electric vehicle (BEV), hybrid plug-in electric vehicle (HPEV), plug-in electric vehicle (PEV), or the like.

Although the charging apparatus for a vehicle 20 is generally described herein as being connected is an electric vehicle, the disclosure is not so limited, and that the slow charging cable 20 may be connected to various other vehicles or devices, such as motorcycles, carts, scooters, and electric bicycles.

The ICCB 100 allows charging power to be applied to the electric vehicle 10 by switching on an internal relay. In addition, the ICCB 100 may perform a protection function to protect a user and the electric vehicle 10 from overvoltage or overcurrent during a battery charging operation. The ICCB 100 may detect a fault during a charging operation, and may include a display module 130 displaying a fault code when a fault is detected.

In an embodiment, as illustrated in FIG. 2, a display module 130 may be provided on a surface of a case 101 of the ICCB 100.

According to an embodiment, the display module 130 may include a plurality of light emitting diodes (LEDs) 131-1 to 131-N on a surface of the ICCB 100.

The plurality of LEDs 131-1 to 131-N may be arranged in a vertical direction. On one side of each of the plurality of LEDs 131-1 to 131-N, the magnitudes of a charging current, in amperes (A), may be displayed to increase in an upward direction. For example, the magnitudes of the charging current may be displayed as 32 A, 24 A, 16 A, 12 A, 10 A, 8 A, and 6 A increasing in the upward direction. During a charging operation, the number of LEDs to be turned on may be controlled in proportion to the magnitude of the charging current. For example, FIG. 2 illustrates a display of a charging current being 10 A.

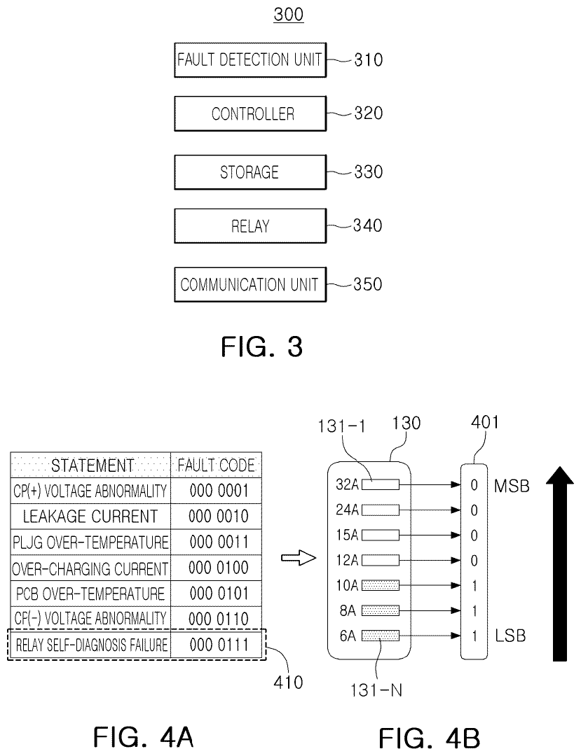

FIG. 3 is a block diagram of a control device of a display module provided in an ICCB, according to an embodiment of the present disclosure. FIGS. 4A and 4B are diagrams illustrating a process of controlling ON/OFF switching of each of a plurality of LEDs according to a stored fault code, according to an embodiment of the present disclosure.

As illustrated in FIG. 3, a control device 300 of the display module 130 may include a fault detection unit 310, a controller 320, a storage 330, a relay 340, and a communication unit 350.

As illustrated in FIG. 4A, the storage 330 may pre-store a fault code corresponding to statements of each fault. For example, reference numeral 410 denotes that corresponding fault code is 000 0111 when a statement is relay self-diagnosis failure.

As illustrated in FIG. 4B, the fault code may be a binary code 401 having a preset number of bits. When the plurality of LEDs 131-1 to 131-N are provided in the display module 130, one LED may correspond to each bit of the binary code 401.

A bit corresponding to the LED 131-1 disposed at the top of the binary code 401 is a most significant bit (MSB), and a bit corresponding to the LED 131-N disposed at the bottom is a least significant bit (LSB).

The fault detection unit 310 may detect a fault during a charging operation through the ICCB 100.

The fault detection unit 310 may include a diagnosis unit of a zero current transformer (ZCS) for detecting a leakage current, a diagnosis unit of the relay 340, a voltage detection unit detecting a charging voltage, a current detection unit detecting a charging current, a temperature sensor detecting temperature, a voltage detection unit detecting a control pilot (CP) voltage. The aforementioned diagnosis unit, voltage detection unit, current detection unit, temperature sensor, and the like are widely known technologies in the art, and thus, detailed descriptions thereof have been omitted.

When a fault is detected, the fault detection unit 310 may transfer a fault code corresponding to the statement of the fault to the controller 320 with reference to the storage 330.

The controller 320 may control the display module 130 when a fault is detected.

In an embodiment, the controller 320 may control ON/OFF switching of each of the plurality of LEDs 131-1 to 131-N provided in the display module 130 according to a fault code corresponding to the statement of the fault transmitted from the fault detection unit 310.

For example, as illustrated in FIGS. 4A and 4B, when the fault code transmitted from the fault detection unit 310 is 0000111, the controller 320 may turn on an LED corresponding to a bit having a fault code of “1”, among the plurality of LEDs 131-1 to 131-N provided on the display module 130, and turn off an LED corresponding to a bit having a fault code of “0”, thereby controlling each of the plurality of LEDs 131-1 to 131-N. Therefore, the LEDs corresponding to the bit having a fault code of “1” (corresponding current magnitudes are 6 A, 8 A, and 10 A) are turned on, and the LEDs corresponding to the bit having a fault code of “0” (corresponding current magnitudes are 12 A, 16 A, 24 A, and 32 A) may be turned off.

Also, during the charging operation, the controller 320 may control the number of LEDs to be turned on in proportion to the magnitude of the charging current, as illustrated in FIG. 2.

In an embodiment, when a fault is detected, the controller 320 may turn off a plurality of LEDs and control the relay 340 to cut off supply of charging power.

The relay 340 may thus supply charging power to the electric vehicle or cut off charging power supplied to the electric vehicle under the control of the controller 320.

The communication unit 350 is a module for communication with an external device. For example, under the control of the controller 320, the communication unit 350 may transmit a magnitude of the charging current to an external device during the charging operation. As another example, when a fault is detected, the communication unit 350 may transmit a statement of the fault and a fault code corresponding to the statement to an external device. The external device may include various devices, for example, a desktop computer, a laptop computer, a notebook, a smartphone, a tablet PC, a mobile phone, and a smart watch.

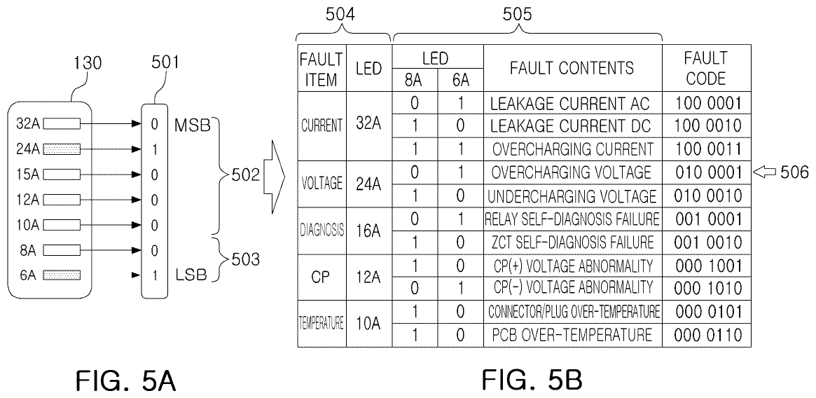

FIGS. 5A and 5B are diagrams illustrating fault codes classified according to fault items and statements, according to an embodiment of the present disclosure.

As illustrated in FIG. 5A, a preset number of bits 502 including one or more MSBs of a fault code 501, e.g., the upper five bits, may indicate fault items. In addition, in the fault code 501, bits 503 excluding the preset number of bits, e.g., the lower 2 bits, may indicate statements.

The fault items may include, for example, at least one of current, voltage, diagnosis, control pilot (CP), and temperature as illustrated in FIG. 5B. Referring to columns 504 in FIG. 5B, in an embodiment, LEDs corresponding to the fixed fault item are 32 A, 24 A, 16 A, 12 A, 10 A, respectively.

In an embodiment, as also illustrated in FIG. 5B, the statements may include one or more of: an occurrence of a leakage current or overcharging current in the case of current; an occurrence of overcharging voltage or undercharging voltage in the case of voltage; a relay self-diagnosis failure or a self-diagnosis failure of a zero-phase current transformer (ZCT) in the case of diagnosis; abnormality of a CP voltage in the case of CP; and/or an occurrence of an over-temperature of a connector, plug or ICCB in the case of temperature. Referring to columns 505 in FIG. 5B, each statement may be indicated by a combination of LEDs 8 A and 6 A corresponding to the lower 2 bits. The fault codes (e.g., the fault codes illustrated in FIG. 5B) may be stored in the storage 330.

Referring again to FIG. 5A, with the fault code being 0100001, LEDs corresponding to 24 A and 6 A of the display module 130 may be turned on. Referring now to FIG. 5B, with the second bit among the upper 5 bits in the fault code (0100001) is ‘1’, the fault item is voltage. Further, with the lower 2 bits being ‘01,’ the display module 160 may indicate that overcharging voltage has occurred (506).

In embodiments, by classifying the upper 5 bits and the lower 2 bits of the fault code in this manner, there is an advantage in that the fault item and statement may be distinguished and indicated.

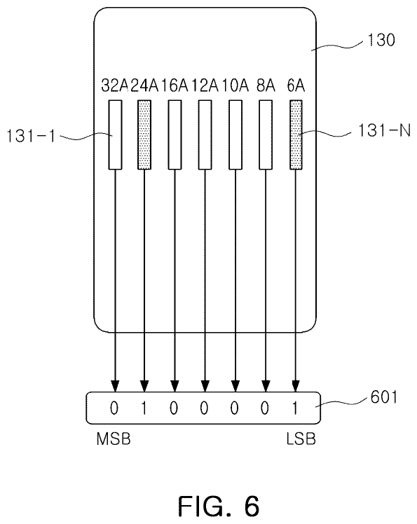

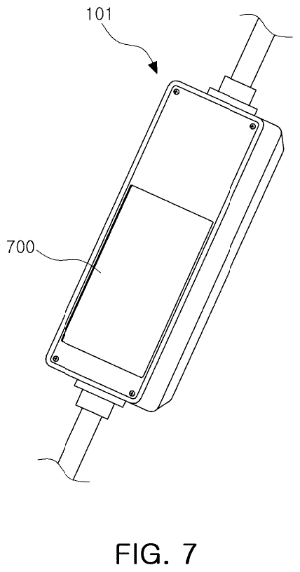

FIG. 6 is a diagram illustrating a plurality of LEDs disposed in a horizontal direction according, to another embodiment of the present disclosure. In the embodiment of FIG. 2, the plurality of LEDs 131-1 to 131-N are arranged in a vertical direction. On the other hand, in the embodiment of FIG. 6, the plurality of LEDs 131-1 to 131-N are arranged in the horizontal direction.

Referring to FIG. 6, the plurality of LEDs 131-1 to 131-N disposed on the display module 130 may be disposed in the horizontal direction. In an embodiment, The magnitudes of charging currents may be displayed on one sides of the plurality of LEDs 131-1 to 131-N to increase in a leftward direction, respectively. In a binary code 601, a bit corresponding to the leftmost LED 131-1 may be the MSB, and a bit corresponding to the rightmost LED 131-N may be the LSB.

FIG. 7 is a diagram illustrating a label attached to an outer surface of an ICCB, according to an embodiment of the present disclosure.

As illustrated in FIG. 7, a label 700 may be attached to a surface of a case 101 of the ICCB 100. For example, the label 700 may be attached to a surface opposite to a surface provided with the display module. The label 700 may display a fault code corresponding to each statement of faults. is the label 700 may be intended for a user who is not familiar with the fault codes, and the user may identify a fault item or a statement according to turned-on LEDs of the display module 130 by referring to the contents of the label 700. On the label, for example, contents, such as FIG. 4A and/or FIG. 5B may be displayed.

As described above, according to embodiments, when a fault is detected during a charging operation through the ICCB, ON/OFF switching of each of a plurality of LEDs may be controlled according to a fault code corresponding to the statement of the fault, thereby reducing size, cost and weight, compared to systems in which a conventional LCD is utilized.

In addition, according to embodiments, a development period may be reduced through relatively easy LED control.

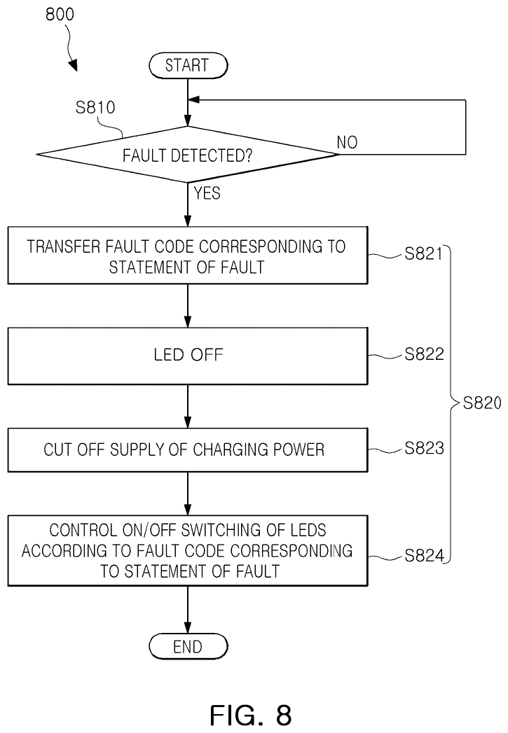

FIG. 8 is a flowchart illustrating a control method 800 of a display module provided in an ICCB, according to an embodiment of the present disclosure.

The control method 800 is described below with reference to FIGS. 1-7. Repeated descriptions of FIGS. 1-7 have been omitted for the purpose of conciseness.

In operation S810, the fault detection unit 310 may detect a fault during a charging operation through the ICCB 100.

The fault detection unit 310 may include a diagnosis unit of a ZCT detecting a leakage current, a diagnosis unit of the relay 340, a voltage detection unit detecting a charging voltage, a current detection unit detecting a charging current, a temperature sensor detecting temperature, a voltage detection unit detecting a CP voltage, and the like, as described above.

In operation S820, the controller 320 may control the display module 130 when a fault is detected.

For example, when a fault is detected, the fault detection unit 310 may transfer a fault code corresponding to a statement of the fault to the controller 320 with reference to the storage 330 in operation S821.

In operation S822, the controller 320 may turn off a plurality of LEDs.

In operation S823, the controller 320 may control the relay 340 to cut off supply of charging power.

In operation S824, the controller 320 may control ON/OFF switching of each of the plurality of LEDs 131-1 to 131-N provided in the display module 130 according to the fault code corresponding to the statement of the fault transmitted from the fault detection unit 310.

For example, when a bit of the fault code is ‘1’, the controller 320 may turn on an LED corresponding to the bit, and when the bit is ‘0’, the controller 320 may turn off an LED corresponding to the bit, as described above.

According to embodiments, as described above, the display module 130 may include a plurality of LEDs 131-1 to 131-N on a surface of the ICCB 100.

According to embodiments, a plurality of LEDs may be disposed in the vertical direction, the magnitudes of the charging current may be displayed on one side of each of the plurality of LEDs so as to increase in the upward direction. In the fault code, the bit corresponding to the uppermost LED is the MSB and the bit corresponding to the lowermost LED may be the LSB, as described above.

According to other embodiments, a plurality of LEDs may be disposed in the horizontal direction, the magnitudes of the charging current may be displayed on one side of each of the plurality of LEDs so as to increase in the left direction. In the fault code, the bit corresponding to the leftmost LED may be the MSB and the bit corresponding to the rightmost LED may be the LSB, as described above.

According to embodiments, the fault code is a binary code having a preset number of bits, and each bit may correspond to one LED as described above.

According to embodiments, a preset number of bits including the MSB in fault codes indicates fault items, and bits other than the preset number of bits in the fault codes include statements included in each of the fault items, as described above.

According to embodiments, the fault items may include at least one of current, voltage, diagnosis, CP, and temperature. The statements may include one or more of: an occurrence of a leakage current or overcharging current in the case of current; an occurrence of overcharging voltage or undercharging voltage in the case of voltage; a relay self-diagnosis failure or a self-diagnosis failure of a ZCT in the case of diagnosis; abnormality of a CP voltage in the case of CP; and/or an occurrence of an over-temperature of a connector, plug or ICCB in the case of temperature, as described above.

The controller 320 may control the number of LEDs that are turned on in proportion to the magnitude of the charging current during the charging operation, as described above.

According to embodiments, when a fault is detected during a charging operation through the ICCB, ON/OFF switching of each of a plurality of LEDs may be controlled according to a fault code corresponding to the statement of the fault, thereby reducing size, cost and weight, compared to systems in which a conventional LCD is utilized.

According to embodiments, a development period may be reduced through relatively easy LED control.

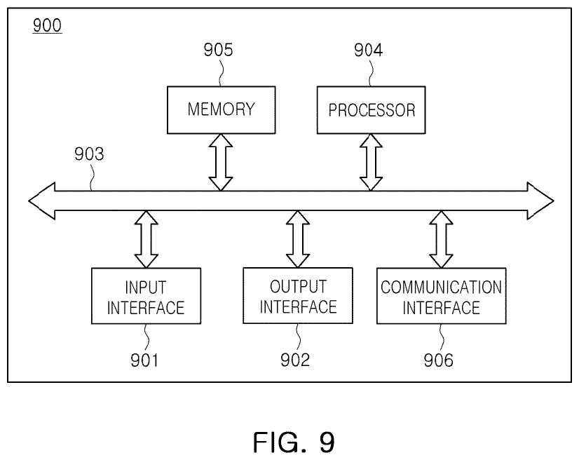

FIG. 9 is a block diagram of a computer device 900 capable of fully or partially implementing a charging apparatus for a vehicle, according to an embodiment of the present disclosure. In an embodiment, the control device 300 illustrated in FIG. 2 may include the computer device 900.

As illustrated in FIG. 9, the computer device 900 may include an input interface 901, an output interface 902, a processor 904, a memory 905, and a communication interface 906. The input interface 901, the output interface 902, the processor 904, the memory 905, and the communication interface 906 may be interconnected through a system bus 903.

In an embodiment, the memory 905 may store programs, instructions, or code, and the processor 904 may execute the programs, instructions, or code stored in the memory 905. The processor 904 may receive a signal by controlling the input interface 901 and may transmit a signal by controlling the output interface 902. The aforementioned memory 905 may include read-only memory (ROM) and random access memory (RAM), and may provide instructions and data to the processor 904.

In an embodiment, the processor 904 may be a central processing unit (CPU), another general-purpose processor, a digital signal processor (DSP), an application specific integrated circuit (ASIC), a field programmable gate array (FPGA) or other programmable logic device, discrete gate or transistor logic device, discrete hardware component, etc. A general-purpose processor may be a microprocessor, or the corresponding processor may be any conventional processor or the like.

In an implementation process, a method performed in each device of FIG. 1 may be achieved by an integrated logic circuit of hardware in the processor 904 or an instruction in the form of software. Contents of a method disclosed in relation to embodiments of the present disclosure may be implemented to be performed by a hardware processor or a combination of hardware and software modules of a processor to be performed. The software module may be disposed in a storage medium, such as RAM, flash memory, ROM, programmable ROM or electrically erasable programmable memory, registers, or the like. The storage medium may be located in the memory 905, and the processor 904 may read information from the memory 905 and may use hardware to implement the operations of the method described above. To avoid redundancy, detailed descriptions thereof are omitted here.

According to embodiments of the present disclosure, when a fault is detected during a charging operation through the ICCB, ON/OFF switching of each of a plurality of LEDs may be controlled according to a fault code corresponding to the statement of the fault, thereby reducing size, cost and weight, compared to systems in which a conventional LCD is utilized.

In addition, according to embodiments of the present disclosure, a development period may be reduced through relatively easy LED control.

While example embodiments have been described above, it should be apparent to those having ordinary skill in the art that modifications and variations may be made without departing from the scope of the present disclosure.

1. A charging apparatus for a vehicle, the charging apparatus comprising:
a display unit displaying a charging state and a fault code for a cause of a charging failure;
a storage unit storing a program for controlling the display unit when a failure is detected during a charging operation; and
a controller controlling the charging operation and controlling the display unit to display a fault code when a failure is detected during the charging operation.

2. The charging apparatus of claim 1, wherein the display unit includes one or more light emitting diodes (LEDs).

3. The charging apparatus of claim 2, wherein the controller controls ON/OFF switching of each of the one or more LEDs according to the fault code.

4. The charging apparatus of claim 2, wherein the controller controls the one or more LEDs, which corresponds to a magnitude of a charging current, to be turned on during the charging operation.

5. The charging apparatus of claim 2, wherein the one or more LEDs are arranged in a vertical direction or horizontal direction and include LEDs ranging from an LED corresponding to a most significant bit (MSB) to an LED corresponding to a least significant bit (LSB) in a certain direction.

6. The charging apparatus of claim 1, wherein the fault code is a binary code having a preset number of bits.

7. The charging apparatus of claim 1, wherein the storage unit pre-stores a fault code corresponding to details of the failure.

8. The charging apparatus of claim 1, wherein the controller controls the display unit so that up to a predetermined number of bits including an MSB display a fault item and bits other than the predetermined number of bits displaying the fault item display details included in each fault item.

9. The charging apparatus of claim 8, wherein the fault item includes at least one of current, voltage, diagnosis, control pilot (CP), and temperature, and the details include at least one of occurrences of leakage current, overcharging current, overcharging voltage, undercharging voltage, relay self-diagnosis failure, self-diagnosis failure of a zero-phase current transformer (ZCT), abnormality of a CP voltage, overtemperature of a connector, overtemperature of a plug, and overtemperature of a printed circuit board (PCB).

10. A method of controlling display of a charging apparatus for a vehicle, the method comprising:
displaying a charging state during a charging operation and detecting a failure; and
controlling a display unit to display a fault code, when the failure is detected.

11. The method of claim 10, wherein the display unit includes one or more light emitting diodes (LED).

12. The method of claim 11, wherein the controlling of the display unit includes controlling ON/OFF switching of the one or more LEDs according to the fault code.

13. The method of claim 11, wherein the controlling of the display unit includes controlling the one or more LEDs, which corresponds to a magnitude of a charging current, to be turned on during the charging operation.

14. The method of claim 11, wherein the one or more LEDs are arranged in a vertical direction or horizontal direction and include LEDs ranging from an LED corresponding to a most significant bit (MSB) to an LED corresponding to a least significant bit (LSB) in a certain direction.

15. The method of claim 10, wherein the fault code is a binary code having a preset number of bits.

16. The method of claim 10, wherein a fault code corresponding to details of the failure is pre-stored.

17. The method of claim 10, wherein the controlling of the display unit includes controlling the display unit so that up to a predetermined number of bits including an MSB display a fault item and bits other than the predetermined number of bits displaying the fault item display details included in each fault item.

18. The method of claim 17, wherein the fault item includes at least one of current, voltage, diagnosis, control pilot (CP), and temperature, and the details include at least one of occurrences of leakage current, overcharging current, overcharging voltage, undercharging voltage, relay self-diagnosis failure, self-diagnosis failure of a zero-phase current transformer (ZCT), abnormality of a CP voltage, overtemperature of a connector, overtemperature of a plug, and overtemperature of a printed circuit board (PCB).

19. A non-transitory computer-readable storage medium storing a program recorded thereon, the program to direct a processor to perform acts of:
displaying a charging state during a charging operation and detecting a failure; and
controlling a display unit to display a fault code when the failure is detected.
